(19) United States
(12) Patent Application Publication
(10) Pub. No.: US 2014/0147123 A1
(43) Pub. Date: May 29, 2014

(54) REMOTE CONTROL

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: WEI-GUO XIAO, Shenzhen (CN); YI-YING CHEN, New Taipei (TW); CHIU-HSIUNG LIN, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/846,919

(22) Filed: Mar. 18, 2013

(30) Foreign Application Priority Data
Nov. 27, 2012 (CN) 201220634980.7

(51) Int. Cl. G08C 23/04

(52) U.S. Cl. CPC G08C 23/04
USPC 398/106

(57) ABSTRACT

A remote control including a base defined an opening is provide. The base includes a circuit board, an infrared emitted tube, a transparent touch screen panel locating corresponding to the opening; a light guide plate adhered to the touch screen panel; a plurality of LEDs fixed to one end of the light guide plate; and alphanumeric characters of keys set between the light guide plate and the touch screen panel.

### BACKGROUND

1. Technical Field

The present disclosure relates to a remote control and more particularly, to a transparent remote control.

2. Description of Related Art

Remote controls include a plastic shell with a circuit board in the shell. Several keys labeled with alphanumeric characters are set on the shell for inputting remote control commands. Typically, the plastic shell is made of opaque material, users with the help of the external environment light identify the function of the keys on the remote control, and thus, in the dark, users cannot use the remote control as they cannot make out the alphanumeric characters. In addition, the alphanumeric characters are subject to wear and tear after a long-term use and cannot be clearly seen, which causes inconvenience to the users. Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a remote control according to an exemplary embodiment.

FIG. 2 is a partial view of the remote control of FIG. 1.

FIG. 3 is similar to FIG. 1, but viewed from a different viewpoint.

FIG. 4 is a view of the remote control of FIG. 1, in using state.

FIG. 5 is a light guide schematic view of a light guide plate of a remote control of FIG. 1.

### DETAILED DESCRIPTION

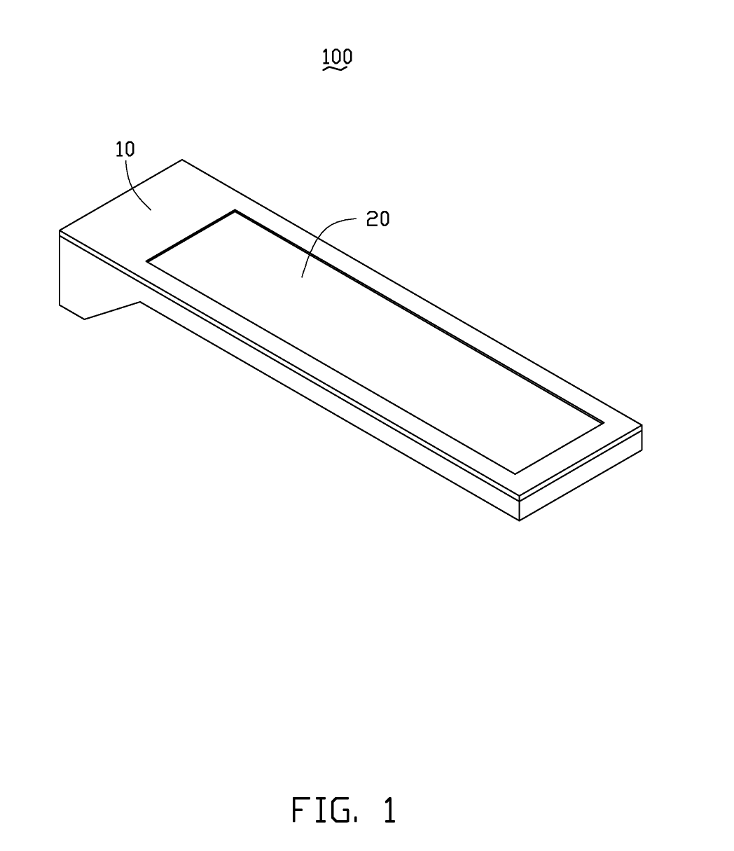

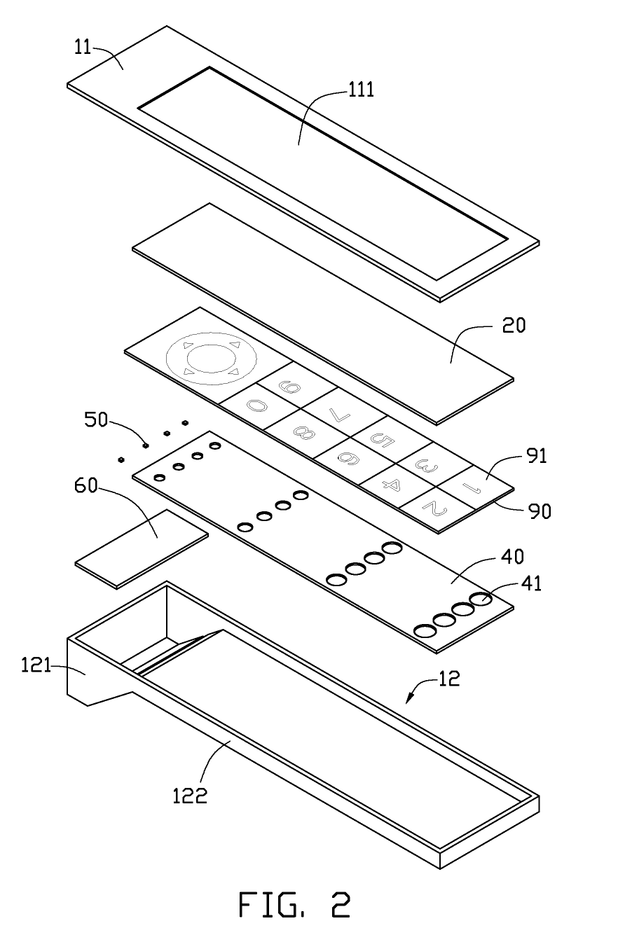

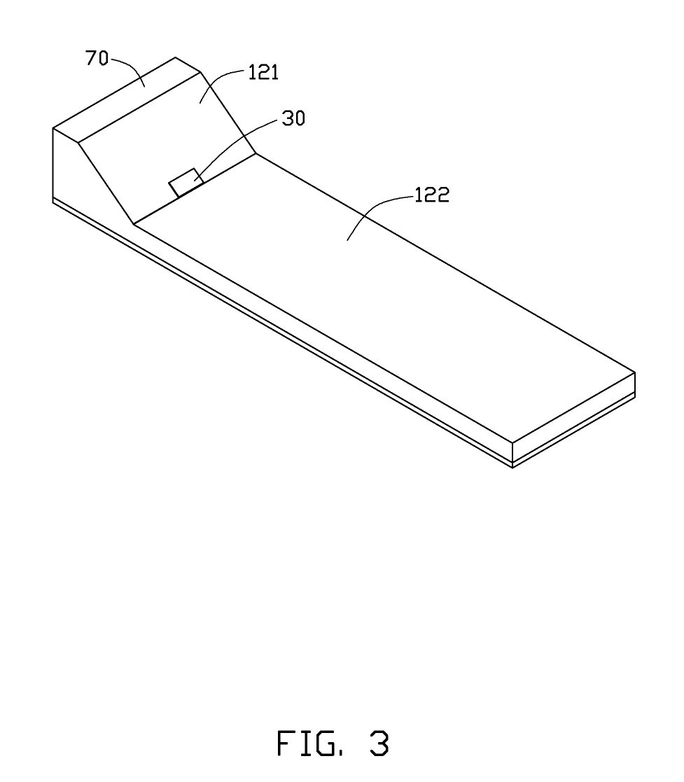

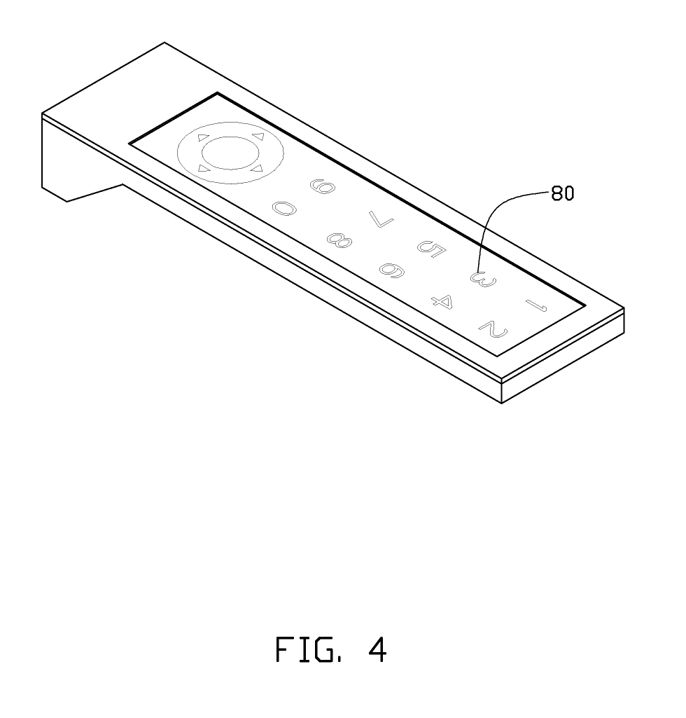

FIGS. 1-4 is a remote control 100 according to an exemplary embodiment. The remote control 100 includes a case 10, a transparent touch screen panel 20 received in the case 10, and an infrared light emitter 30 for emitting remote control signals. In the embodiment, the touch screen panel 20 is a resistive touch screen panel, a capacitive touch screen panel or an optical touch screen panel.

The remote control 100 also includes a light guide plate 40, a number of LEDs (light emitting diode) 50 and a circuit board 60, which are all received in the case 10.

The case 10 is L-shaped and includes an upper cover 11 and a lower housing 12 matching with the upper cover. The upper cover 10 is plateshaped and defines an opening 111. The lower housing includes an upper portion engaged with the upper cover 10 and a protrusion portion 121 protruding from the upper portion. A grip 70 is formed by the protrusion portion 121 combining with the upper cover 11 to allow the user to hold the remote control 100 easily.

The touch screen panel 20 is exposed to the opening 111 to allow the user to conveniently use the remote control 100. The light guide plate 40 is attached to the touch screen panel 20 by optical adhesives. A plurality of keys 91 with alphanumeric characters 80 are formed on the light guide plate 40. In the embodiment, A plurality of keys 91 with alphanumeric characters 80 are formed on a thin film 90. The thin film 90 is adhered onto the light guide plate 40 or the touch screen panel 20 using optical enhancement film or optical enhancement glue. In another embodiment, keys 91 with alphanumeric characters 80 are formed on the light guide plate 40 using laser or an etching process. Thus, there is no need to set keys on the outside surface of the remote control 100 and the thickness of the remote control 100 is reduced.

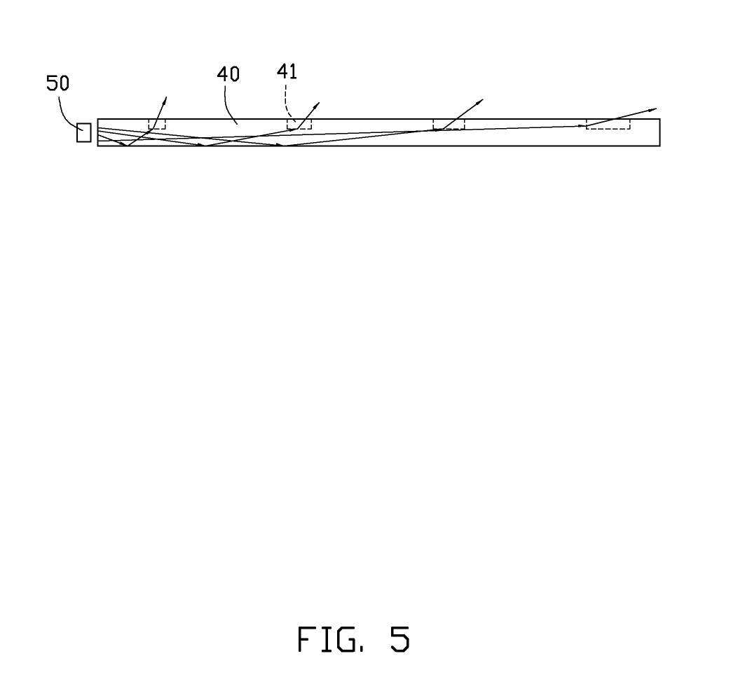

The LEDs 50 are arranged adjacent to one end of the light guide plate 40 and facing toward light guide plate 40. The LEDs 50 are on the same horizontal plane with the light guide plate 40. Multiple rows of light exiting outlets 41 are arranged uniformly on the light guide plate 40. Every row of light exiting outlets 41 includes a plurality of concave or convex light exiting outlets 41. The surface of the light guide plate 40 facing the touch screen panel 20 and the surface opposite to the surface facing the touch screen panel 20 are coated with an opaque film to block the light emitted by the LEDs 50 from emitting out from those surfaces. Thus, the light emitted by the LEDs 50 is guided by the light guide plate 40 to each of the light exiting outlets 41 and emitted out from the light exiting outlets 41. In the embodiment, the light exiting outlets 41 are concave and have no keys located underneath. The light exiting outlets 41 away from the LEDs 50 have larger diameters than those close the LEDs 50. In another embodiment, more light exiting outlets 41 are distributed as the distance between the light exiting outlets 41 and the LEDs 50 increases. In other embodiments, alphanumeric characters 80 of keys 91 are adhered to the touch screen panel 20, the light exiting outlets 41 are located underneath the key. Referring to FIG. 5, the light emitted by the LEDs 50 is guided by the light guide plate 40 and emit out from the light exiting outlets 41 to provide backlight to the remote control 100. Thus, users can clearly see alphanumeric characters of keys on the remote control 100.

The circuit board 60 is received in the protrusion portion 121 and electronically connected to the touch screen panel 20, LEDs 50 and infrared light emitter 30.

The infrared light emitter 30 is mounted on the outside surface of the protrusion portion 121 contacting the plate-shaped portion 122. Thus, the length of wire connecting the infrared light emitter 30 and the circuit board 60 is reduced or even can be omitted, furthermore, when users use the remote control 100, infrared rays that are emitted by the infrared light emitter 30 pointed to devices as selected by the users.

When user touches the touch screen panel 20, the touch screen panel 20 detects the touch operation, the processor energizes the LEDs 50. The light beams emitted from the LEDs 50 are guided by the light guide plate 40 to light the alphanumeric characters 80 of the keys 91 on the remote control 100. Thus, user can see clearly the alphanumeric characters 80. Furthermore, the processor generates a remote control signal corresponding to the alphanumeric characters 80 of keys 91, which is touched by users. The remote control signal is transmitted by the infrared light emitter 30 to remote control the devices.

The remote control 100 of the present disclosure includes a transparent touch screen panel 20 and alphanumeric characters 80 of keys 91 are located under the touch screen panel 20. Thus, the thickness of the remote control 100 is reduced, alphanumeric characters 80 of the keys 91 will not be subject wear and tear, and the service life of the remote control 100 is extended. Furthermore, LEDs 50 provides light to the remote control 100. Thus, remote control 100 can also be used in the dark.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A remote control comprising:
a case defining an opening;
a circuit board received in the case;
an infrared light emitter for emitting remote control signals;
a transparent touch screen panel received in the case and exposed at the opening;
a light guide plate attached to the touch screen panel;
a plurality of LEDs arranged adjacent to one end of the light guide plate; and
a plurality of keys with alphanumeric characters formed on the light guide plate.

2. The remote control described as in claim 1, wherein the alphanumeric characters of keys are formed on the light guide plate using laser or an etching process.

3. A remote control comprising:
a case defining an opening;
a circuit board received in the case;
an infrared light emitter for emitting remote control signals;
a transparent touch screen panel received in the case and exposed at the opening;
a light guide plate attached to the touch screen panel;
a plurality of LEDs arranged adjacent to one end of the light guide plate; and
a thin film having a plurality of keys with alphanumeric characters formed thereon.

4. The remote control described as in claim 3, wherein the thin film is adhered onto the light guide plate.

5. The remote control described as in claim 3, wherein the thin film is adhered onto the touch screen panel.

6. The remote control described as in claim 4, wherein the thin film is adhered on the light guide plate using an optical enhancement film or optical enhancement glue.

7. The remote control described as in claim 5, wherein the thin film is adhered on the touch screen panel using an optical enhancement film or optical enhancement glue.

8. The remote control described as in claim 3, wherein the base comprises a plate-shaped upper cover and a lower housing matching with the upper cover, the lower housing includes an upper portion engaged with the upper cover and a protrusion portion protruding from the upper portion.

9. The remote control described as in claim 8, wherein the circuit board is received in the protrusion portion, the infrared light emitter is mounted on an outside surface of the protrusion portion.

10. The remote control described as in claim 8, wherein the plurality of LEDs are faced toward the light guide plate.

11. The remote control described as in claim 3, wherein the touch screen panel is a resistive touch screen panel, a capacitive touch screen panel or an optical touch screen panel.

12. The remote control described as in claim 3, wherein the light guide plate includes a plurality of concave or convex light exiting outlets.
